(19) United States
(12) Patent Application Publication
(10) Pub. No.: US 2017/0153919 A1
(43) Pub. Date: Jun. 1, 2017

(54) SYSTEM FOR ANALYZING RESOURCE CAPACITY BASED ON ASSOCIATED DEPENDENCIES

(71) Applicant: BANK OF AMERICA CORPORATION, Charlotte, NC (US)

(72) Inventors: Alicia C. Jones-McFadden, Fort Mill, SC (US); Katherine Dintenfass, Charlotte, NC (US); Alexander C. Wittkowski, Charlotte, NC (US); Damon C. Missouri, Trenton, NJ (US); Cameron Darnell Wadley, Waxhaw, NC (US)

(21) Appl. No.: 14/954,599

(22) Filed: Nov. 30, 2015

(51) Int. Cl. G06F 9/50; G06F 9/48

(52) U.S. Cl. CPC G06F 9/5011; G06F 9/4881

(57) ABSTRACT

Systems, computer program products, and methods are described herein for analyzing resource capacity based on associated dependencies. The present invention is configured to determine a resource capacity associated with an entity; determine one or more dependencies associated with the entity, wherein the one or more dependencies are associated with a resource value; receive a user input, wherein the user input comprises a dynamic allocation of the one or more dependencies to the entity; determine an aggregated resource value based on at least receiving the user input, wherein the aggregated resource value comprises an aggregate of the resource values associated with the one or more dependencies dynamically allocated to the entity; and initiate a presentation of a dynamic display, wherein the dynamic display comprises an indication of the resource capacity associated with the entity and an aggregated resource value associated with the one or more dependencies dynamically allocated to the entity.

### BACKGROUND

Planning for and determining how resources will be dispersed is an important aspect of a company's decision regarding the allocation of the company's resources. Companies attempt to allocate resources in a manner that helps minimize cost while maximizing profit. This is typically done by using strategic planning methods to structure the operation, establish operational guidelines, and implement policies and procedures that move the business toward the achievement of its goals. However, while companies increasingly tend to direct their resources into disparate structures, the technology associated with dynamic asset allocation is still a limited area.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, systems, computer program products, and methods are described herein for electronic visualization and virtual connection to dependencies. In one embodiment, a system for electronic visualization and virtual connection to dependencies is presented. The system comprises: at least one non-transitory storage device; at least one processor; and at least one module stored in said storage device and comprising instruction code that is executable by the at least one processor and configured to cause said at least one processor to: determine a resource capacity associated with an entity; determine one or more dependencies associated with the entity, wherein the one or more dependencies are associated with a resource value; receive a user input, wherein the user input comprises a dynamic allocation of the one or more dependencies to the entity; determine an aggregated resource value based on at least receiving the user input, wherein the aggregated resource value comprises an aggregate of the resource values associated with the one or more dependencies dynamically allocated to the entity; and initiate a presentation of a dynamic display, wherein the dynamic display comprises an indication of the resource capacity associated with the entity and an aggregated resource value associated with the one or more dependencies dynamically allocated to the entity.

In some embodiments, the module is further configured to cause the at least one processor to determine that the resource value associated with the one or more dependencies are variable between a minimum resource value and a maximum resource value.

In some embodiments, the module is further configured to cause the at least one processor to: determine the aggregate resource value based on at least receiving the user input, wherein the aggregate resource value comprises a minimum resource value and a maximum resource value.

In some embodiments, the module is further configured to cause the at least one processor to: initiate the presentation of the minimum aggregated resource value and the maximum aggregated resource value in addition to the resource capacity associated with the entity.

In some embodiments, the module is further configured to cause the at least one processor to: continuously monitor the resource capacity of the entity and the dynamic allocation of the dependencies to retrieve updated values associated with the resource capacity of the entity and the aggregated resource value associated with the dynamically allocated dependencies, wherein continuously monitoring further comprises continuously updating the dynamic display with the updated values.

In some embodiments, the module is further configured to cause the at least one processor to: determine that the minimum aggregate resource value is greater than the resource capacity of the entity indicating that the entity is unable to handle the current allocation of the one or more dependencies; initiate a presentation of a reallocation interface, wherein the reallocation interface comprises the one or more dependencies currently allocated and one or more other dependencies capable of being allocated to the entity; and receive a user input to redistribute the one or more dependencies, wherein redistributing the one or more dependencies causes a minimum aggregated resource value associated with the redistributed dependencies to be lesser than the resource capacity.

In some embodiments, the module is further configured to cause the at least one processor to: determine that the minimum aggregate resource value is greater than the resource capacity of the entity indicating that the entity is unable to handle the current allocation of the one or more dependencies; initiate a presentation of a resource interface, wherein the resource interface comprises one or more options to increase the resource capacity of the entity; and receive a user input to add one or more resources to the entity, wherein adding the one or more entities causes the minimum aggregated resource value to be lesser than the resource capacity calculated based on the one or more additional resources.

In some embodiments, the module is further configured to cause the at least one processor to: establish a communication link with one or more sources of assets for the user; electronically retrieve information associated with the one or more sources of assets, wherein the information comprises an aggregated asset value, wherein the aggregated asset value comprises an aggregate of asset values associated with each of the one or more sources of assets; establish a communication link with a user device, wherein establishing the communication link creates a wireless data channel to the user device; initiate, via the data channel, a presentation of a dependency interface, wherein the dependency interface comprises one or more dependencies associated with the user, wherein the one or more dependencies is associated with a resource value; electronically receive, via the data channel, a user selection of at least one of the one or more dependencies to be allocated to the user; determine an aggregated resource value based on at least receiving the user selection of at least one of the one or more dependencies, wherein the aggregated resource value comprises an aggregate of the resource values associated with the one or more dependencies allocated to the user; and initiate, via the data channel, a presentation of a display interface, wherein the display interface comprises an aggregated asset value of the user, and the aggregated resource value associated with the at least one of the one or more dependencies selected by the user.

In some embodiments, the module is further configured to cause the at least one processor to determine that the resource value associated with the one or more dependencies are variable between a minimum resource value and a maximum resource value.

In some embodiments, the module is further configured to cause the at least one processor to: determine the aggregate resource value based on at least receiving the user input, wherein the aggregate resource value comprises a minimum resource value and a maximum resource value.

In some embodiments, the module is further configured to cause the at least one processor to: initiate the presentation of the minimum aggregated resource value and the maximum aggregated resource value in addition to the resource capacity associated with the entity.

In some embodiments, the module is further configured to cause the at least one processor to: continuously monitor the resource capacity of the entity and the dynamic allocation of the dependencies to retrieve updated values associated with the resource capacity of the entity and the aggregated resource value associated with the dynamically allocated dependencies, wherein continuously monitoring further comprises continuously updating the dynamic display with the updated values.

In some embodiments, the module is further configured to cause the at least one processor to: determine that the minimum aggregate resource value is greater than the resource capacity of the entity indicating that the entity is unable to handle the current allocation of the one or more dependencies; initiate a presentation of a reallocation interface, wherein the reallocation interface comprises the one or more dependencies currently allocated and one or more other dependencies capable of being allocated to the entity; and receive a user input to redistribute the one or more dependencies, wherein redistributing the one or more dependencies causes a minimum aggregated resource value associated with the redistributed dependencies to be lesser than the resource capacity.

In some embodiments, the module is further configured to cause the at least one processor to: determine that the minimum aggregate resource value is greater than the resource capacity of the entity indicating that the entity is unable to handle the current allocation of the one or more dependencies; initiate a presentation of a resource interface, wherein the resource interface comprises one or more options to increase the resource capacity of the entity; and receive a user input to add one or more resources to the entity, wherein adding the one or more entities causes the minimum aggregated resource value to be lesser than the resource capacity calculated based on the one or more additional resources.

In some embodiments, the module is further configured to cause the at least one processor to: establish a communication link with one or more sources of assets for the user; electronically retrieve information associated with the one or more sources of assets, wherein the information comprises an aggregated asset value, wherein the aggregated asset value comprises an aggregate of asset values associated with each of the one or more sources of assets; establish a communication link with a user device, wherein establishing the communication link creates a wireless data channel to the user device; initiate, via the data channel, a presentation of a dependency interface, wherein the dependency interface comprises one or more dependencies associated with the user, wherein the one or more dependencies is associated with a resource value; electronically receive, via the data channel, a user selection of at least one of the one or more dependencies to be allocated to the user; determine an aggregated resource value based on at least receiving the user selection of at least one of the one or more dependencies, wherein the aggregated resource value comprises an aggregate of the resource values associated with the one or more dependencies allocated to the user; and initiate, via the data channel, a presentation of a display interface, wherein the display interface comprises an aggregated asset value of the user, and the aggregated resource value associated with the at least one of the one or more dependencies selected by the user.

### BRIEF DESCRIPTION OF THE DRAWINGS

Having thus described embodiments of the invention in general terms, reference will now be made to the accompanying drawings, where:

FIG. 1 illustrates technical components of a system for electronic visualization and virtual connection to dependencies, in accordance with an embodiment of the invention;

FIG. 2 illustrates a high level process flow for electronic visualization and virtual connection to dependencies, in accordance with an embodiment of the invention;

FIG. 3 illustrates a process flow for electronic visualization of dependencies selected by the user against the aggregated asset value of the user, in accordance with an embodiment of the invention;

FIG. 4A illustrates an exemplary priority interface, in accordance with an embodiment of the invention;

FIGS. 4B and 4C illustrate an exemplary dependency interface for a family life priority selected by the user, in accordance with an embodiment of the invention;

FIG. 5A illustrates an exemplary interface for adjusting the user's financial ability to afford healthcare post retirement, in accordance with an embodiment of the invention;

FIG. 5B illustrates an exemplary dependency interface associated with a health life priority, in accordance with an embodiment of an invention; and

FIG. 6 illustrates a dynamic display interface, in accordance with an embodiment of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Embodiments of the invention are directed to systems, methods and computer program products for electronic visualization and virtual connection to dependencies. In an economic scenario, the present invention has the functional benefit of providing a visual portrayal of financial status by capturing the transient behavior of a user's resources to determine whether the resources are capable of handling the workloads associated with a plurality of dependents. In doing so, the present invention enables the user to dynamically select one or more dependents and visually portray the user's ability to handle the workload associated with the selected dependents based on the behavior of the user's resources at a particular time instant. In some embodiments, the present invention provides the functional benefit of determining the allocation of the user's resources to be applicable to handle the workload associated with the selected dependents.

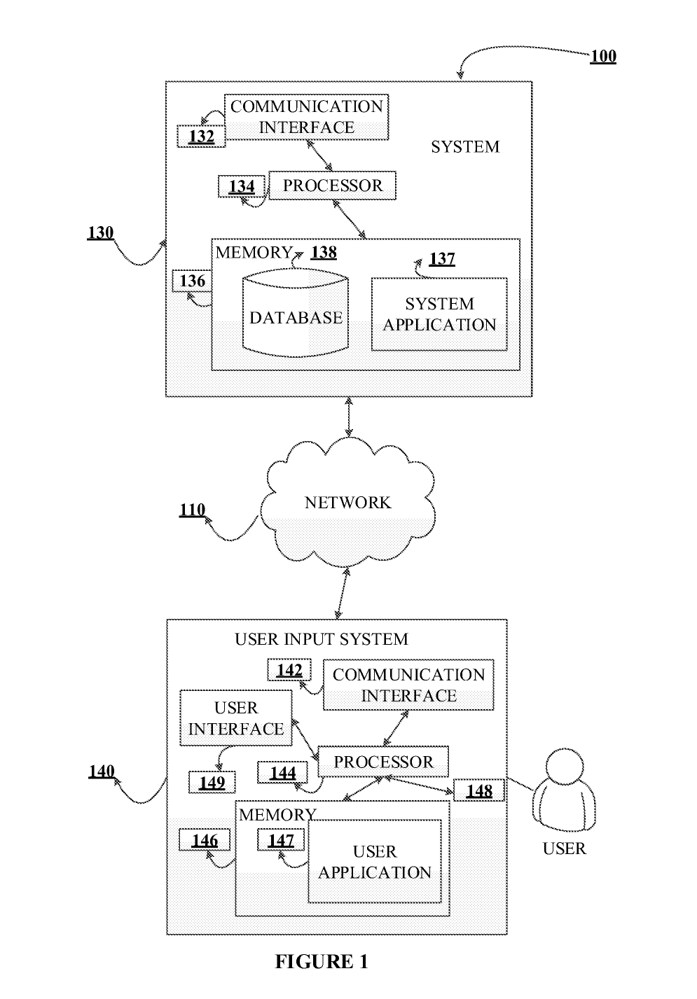

FIG. 1 presents an exemplary block diagram of the system environment 100 for implementing the process flows described herein in accordance with embodiments of the present invention. As illustrated, the system environment 100 includes a network 110, a system 130, and a user input system 140. Also shown in FIG. 1 is a user of the user input system 140. The user input system 140 may be a mobile device or other non-mobile computing device. The user may be a person who uses the user input system 140 to execute a user application 147. The user application 147 may be an application to communicate with the system 130, perform a transaction, input information onto a user interface presented on the user input system 140, or the like. The user application 147 and/or the system application 137 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

The user input system 140 may include any computerized apparatus that can be configured to perform any one or more of the functions of the user input system 140 described and/or contemplated herein. For example, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like. In some embodiments, for example, the user input system 140 may include a personal computer system (e.g. a non-mobile or non-portable computing system, or the like), a mobile computing device, a personal digital assistant, a mobile phone, a tablet computing device, a network device, and/or the like. As illustrated in FIG. 1, in accordance with some embodiments of the present invention, the user input system 140 includes a communication interface 142, a processor 144, a memory 146 having an user application 147 stored therein, and a user interface 149. In such embodiments, the communication interface 142 is operatively and selectively connected to the processor 144, which is operatively and selectively connected to the user interface 149 and the memory 146. In some embodiments, the user may use the user application 147 to execute processes described with respect to the process flows described herein. Specifically, the user application 147 executes the process flows described herein.

Each communication interface described herein, including the communication interface 142, generally includes hardware, and, in some instances, software, that enables the user input system 140, to transport, send, receive, and/or otherwise communicate information to and/or from the communication interface of one or more other systems on the network 110. For example, the communication interface 142 of the user input system 140 may include a wireless transceiver, modem, server, electrical connection, and/or other electronic device that operatively connects the user input system 140 to another system such as the system 130. The wireless transceiver may include a radio circuit to enable wireless transmission and reception of information. Additionally, the user input system 140 may include a positioning system. The positioning system (e.g. a global positioning system (GPS), a network address (IP address) positioning system, a positioning system based on the nearest cell tower location, or the like) may enable at least the user input system 140 or an external server or computing device in communication with the user input system 140 to determine the location (e.g. location coordinates) of the user input system 140.

Each processor described herein, including the processor 144, generally includes circuitry for implementing the audio, visual, and/or logic functions of the user input system 140. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 147 of the memory 146 of the user input system 140.

Each memory device described herein, including the memory 146 for storing the user application 147 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

As shown in FIG. 1, the memory 146 includes the user application 147. In some embodiments, the user application 147 includes an interface for communicating with, navigating, controlling, configuring, and/or using the user input system 140. In some embodiments, the user application 147 includes computer-executable program code portions for instructing the processor 144 to perform one or more of the functions of the user application 147 described and/or contemplated herein. In some embodiments, the user application 147 may include and/or use one or more network and/or system communication protocols.

Also shown in FIG. 1 is the user interface 149. In some embodiments, the user interface 149 includes one or more output devices, such as a display and/or speaker, for presenting information to the user. In some embodiments, the user interface 149 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 149 includes the input and display devices of a mobile device, which are operable to receive and display information.

FIG. 1 also illustrates a system 130, in accordance with an embodiment of the present invention. The system 130 may refer to the “apparatus” described herein. The system 130 may include any computerized apparatus that can be configured to perform any one or more of the functions of the system 130 described and/or contemplated herein. In accordance with some embodiments, for example, the system 130 may include a computer network, an engine, a platform, a server, a database system, a front end system, a back end system, a personal computer system, and/or the like. Therefore, the system 130 may be a server managed by the business. The system 130 may be located at the facility associated with the business or remotely from the facility associated with the business. In some embodiments, such as the one illustrated in FIG. 1, the system 130 includes a communication interface 132, a processor 134, and a memory 136, which includes a system application 137 and a structured database 138 stored therein. As shown, the communication interface 132 is operatively and selectively connected to the processor 134, which is operatively and selectively connected to the memory 136.

It will be understood that the system application 137 may be configured to implement any one or more portions of the various user interfaces and/or process flow described herein. The system application 137 may interact with the user application 147. It will also be understood that, in some embodiments, the memory includes other applications. It will also be understood that, in some embodiments, the system application 137 is configured to communicate with the structured database 138, the user input system 140, or the like.

It will be further understood that, in some embodiments, the system application 137 includes computer-executable program code portions for instructing the processor 134 to perform any one or more of the functions of the system application 137 described and/or contemplated herein. In some embodiments, the system application 137 may include and/or use one or more network and/or system communication protocols.

In addition to the system application 137, the memory 136 also includes the structured database 138. As used herein, the structured database 138 may be one or more distinct and/or remote databases. In some embodiments, the structured database 138 is not located within the system and is instead located remotely from the system. In some embodiments, the structured database 138 stores information or data described herein.

It will be understood that the structured database 138 may include any one or more storage devices, including, but not limited to, datastores, databases, and/or any of the other storage devices typically associated with a computer system. It will also be understood that the structured database 138 may store information in any known way, such as, for example, by using one or more computer codes and/or languages, alphanumeric character strings, data sets, figures, tables, charts, links, documents, and/or the like. Further, in some embodiments, the structured database 138 may include information associated with one or more applications, such as, for example, the system application 137. It will also be understood that, in some embodiments, the structured database 138 provides a substantially real-time representation of the information stored therein, so that, for example, when the processor 134 accesses the structured database 138, the information stored therein is current or substantially current.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

In addition, the various portions of the system environment 100 may be maintained for and/or by the same or separate parties. It will also be understood that the system 130 may include and/or implement any embodiment of the present invention described and/or contemplated herein. For example, in some embodiments, the system 130 is configured to implement any one or more of the embodiments of the process flows described and/or contemplated herein in connection any process flow described herein. Additionally, the system 130 or the user input system 140 is configured to initiate presentation of any of the user interfaces described herein.

Management of dependencies based on resource capacity is on ongoing challenge in most industries. Typically, capacity planning is defined as the process of determining the product capacity needed by an organization to meet changing demands for its products. In some embodiments, capacity planning may be defined as the process of determining what type of hardware and software configuration is required to meet application needs. A successful capacity management plan may be based on monitoring and measuring load data over time and implementing flexible solutions to handle variances without impacting performance. The goal of capacity planning is to identify the right amount of resources required to meet service demands now and in the future. As an important discipline with boundless impact, capacity planning supports information technology and business alignment, helping to show the cost and business need for infrastructure upgrades.

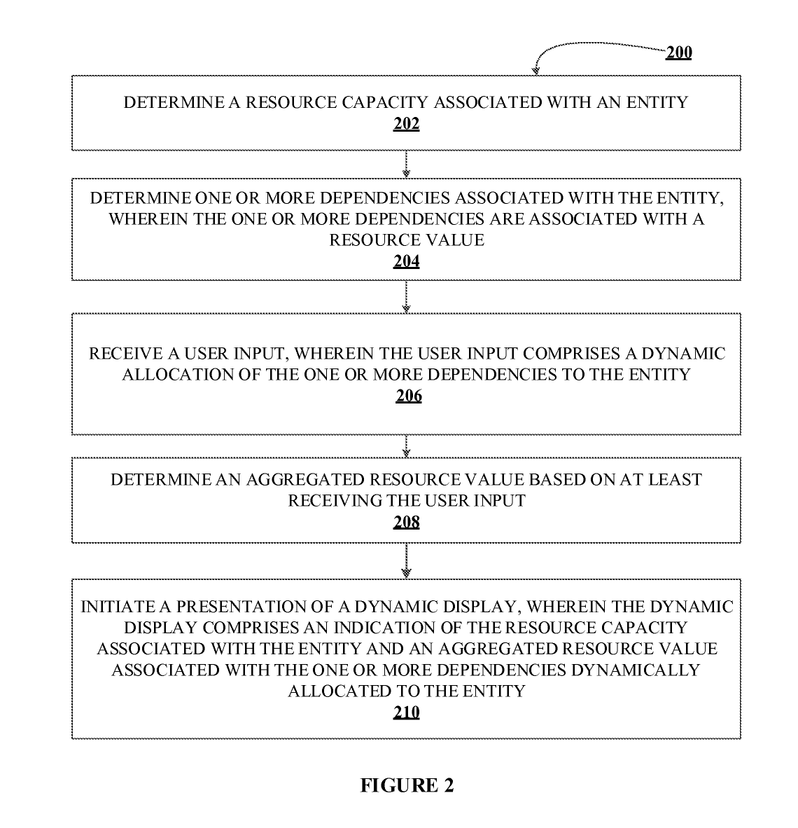

FIG. 2 illustrates a high level process flow for electronic visualization and virtual connection to dependencies 200, in accordance with an embodiment of the invention. As shown in block 202, the process flow includes determining a resource capacity associated with an entity. As used herein, an “entity” may refer to any infrastructure, software or hardware with a predefined capacity capable of handling resource demands. In this regard, an entity may include, but is not limited to hardware configurations such as a number and speed of computer processing unit (CPU) cores, memory size, storage type, or the like, or software configurations such as a required network bandwidth, user capacity, or the like. Each entity may be associated with a resource capacity indicating an amount of workload that the entity is capable of handling at a time.

In another example, an entity may refer to user assets. As used herein, “assets” include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like. In this regard, the resource capacity associated with the assets may be asset values. Typically, an asset value may be defined as the value of the difference between an entity's assets and its liabilities. As used herein, “liabilities” are cash or cash equivalent debt that a user may owe to an entity. Examples of liabilities may include a home mortgage, another type of loan for which the user has to make payments, payments owed to the government, a legal judgment against the user, or any other situation in which the use owes a debt to another entity or person.

In some embodiments, the user's assets may include but are not limited to checking accounts, savings accounts, investment accounts (e.g., with regular disbursements and penalties for principal withdrawals, or self-directed accounts that are liquid without penalties), annuity accounts (e.g., social security, claim awards, reverse mortgages, or the like), insurances benefit accounts (e.g., one time or reoccurring), property owned by the user (e.g., investment property, rental property, or the like), or other like assets that may provide regular or semi-regular recurring payments, assets that are or are similar to cash accounts, or assets that need to be sold in order to realize cash values of the assets. In some embodiments the assets may be illiquid (e.g., have penalties or may take time to convert into cash) or may be liquid (e.g., can be converted to cash immediately or within hours, days, or the like without penalty). In addition, embodiments of the invention further comprise determining a user's liabilities and the values (e.g., amount of debt, or the like) of the liabilities (e.g., amount owed, or the like). The user's liabilities may include a mortgage, long and short term debt (e.g., credit card debt, car loans, boat loans, small business loans, lines of credit, or the like), payments owed on other personal property or legal judgments against the user, or the like.

Next, as shown in block 204, the process flow includes determining one or more dependencies associated with the entity, wherein the one or more dependencies are associated with a resource value. Each dependency creates a workload expectation to the associated entity based on the resource value of the dependency. In some embodiments, the overall workload for the entity may be calculated by aggregating resource values associated with each individual dependency. Typically, the capacity of the entity is planned in such a way that the overall workload expectation of the entity is lesser than the resource capacity associated with the entity.

Continuing with the previous example, the one or more dependencies may refer to one or more individuals who might depend on the user for financial support immediately and/or in retirement. In some embodiments, the one or more dependencies may include, but is not limited to, extended family, grand children, siblings, friends, ex-spouse/ex-partner, spouse/partner, parents, children, charities, or the like. Each dependent determined herein may require financial support from the user, the extent of which may be determined based on a predetermined dependent value associated with each dependent.

Next, as shown in block 206, the process flow includes receiving a user input, wherein the user input comprises a dynamic allocation of the one or more dependencies to the entity. In this regard, the system may be configured to gather and analyze usage patterns associated with the entity and project capacity requirements and performance characteristics. In doing so, the dependencies may be allocated to the entity in accordance with both historic usage capacity and performance of the entity and current performance parameters. In some embodiments, one or more key items influencing dynamic allocation include, but are not limited to a number of concurrent users, user workflows, architecture, tuning and implementation of best practices.

Continuing with the previous example, the system may be configured to enable a user to select one or more dependents from the list of determined dependents. In order to do so, the system may first establish a communication link with a user device (e.g., a mobile device) thereby creating a data link (wired or wireless). In this way, the system may be configured to receive a user selection of at least one of the one or more dependents for allocation.

Next, as shown in block 208, the process flow includes determining an aggregated resource value based on at least receiving the user input. In some embodiments, the resource value associated with a dependency may be variable between a minimum resource value and a maximum resource value. In this regard, the minimum resource value may refer to the absolute minimum amount of resources a dependency may require to remain functioning at the lowest level and the maximum resource value may refer to an amount of resources a dependency requires for the dependency to function at the highest level. In one aspect, a resource value greater than the maximum resource value for a dependency may result in redundancies and unnecessary leakage. In one aspect, the system may be configured to aggregate the resource value of each dependency dynamically as and when the dependency is selected by the user. In another aspect, the system may be configured to aggregate the resource value of the one or more dependencies after the user has selected all the dependencies.

Next, as shown in block 210, the process flow includes initiating a presentation of a dynamic display, wherein the dynamic display comprises an indication of the resource capacity associated with the entity and an aggregated resource value associated with the one or more dependencies dynamically allocated to the entity. In one aspect, the system may be configured to initiate the presentation of the minimum aggregated resource value and the maximum aggregated resource value in addition to the resource capacity associated with the entity. In some embodiments, the system may be configured to aggregate the resource value associated with each dependency and dynamically present the aggregated resource value on the dynamic display, thereby visually representing a comparison between the aggregated resource value and the resource capacity associated with the entity. In doing so, the user may monitor the dynamic display prior to, during, and/or after the selection of the one or more dependencies and adjust the selection accordingly. In some embodiments, the system may be configured to continuously monitor the resource capacity of the entity and the dynamic allocation of the dependencies to retrieve updated values associated with the resource capacity of the entity and the aggregated resource value associated with the dynamically allocated dependencies, and update the dynamic display with the updated values.

In some embodiments, the system may be configured to determine that the minimum aggregate resource value is greater than the resource capacity of the entity indicating that the entity is unable to handle the current allocation of the one or more dependencies. In one aspect, in response, the system may be configured to initiate a presentation of a reallocation interface to reorganize the assignment of the dependencies. In this regard, the reallocation interface includes the one or more dependencies currently allocated and one or more other dependencies capable of being allocated to the entity. The user may redistribute the one or more dependencies using the reallocation interface in such a way that the redistribution causes a minimum aggregated resource value associated with the redistributed dependencies to be lesser than the resource capacity. In another aspect, in response, the system may be configured to initiate a presentation of a resource interface to provide one or more options for the user to increase the resource capacity of the entity. The user may then add one or more resources to the entity in such a way that the minimum aggregated resource value is lesser than the resource capacity calculated based on the one or more additional resources.

Continuing from the previous example, with the presentation of the dynamic display, the user may be able to determine whether the asset value of the user is capable of supporting the one or more dependents selected by the user. In this regard, the system may be configured to establish a communication link with the user device, thereby creating a data channel between the system and the user device. In some embodiments, the dependency interface, display interface, and any other interfaces associated with the system may be presented on the user device in associated with a dependency application installed on the user device. In one aspect, the initiation of any of the interfaces described herein may cause the dependency application installed on the user device to launch on the otherwise dormant user device. In some embodiments, the dependency application may be running in the background of the user device. In some other embodiments, the dependency application may not be running in the background of the user device. In some embodiments, the dependency application may be part of another application, such as an online banking application installed on the user device. In some other embodiments, the dependency application may be stand-alone application installed on the user device, when initiated, is capable of communicating with the user's asset information.

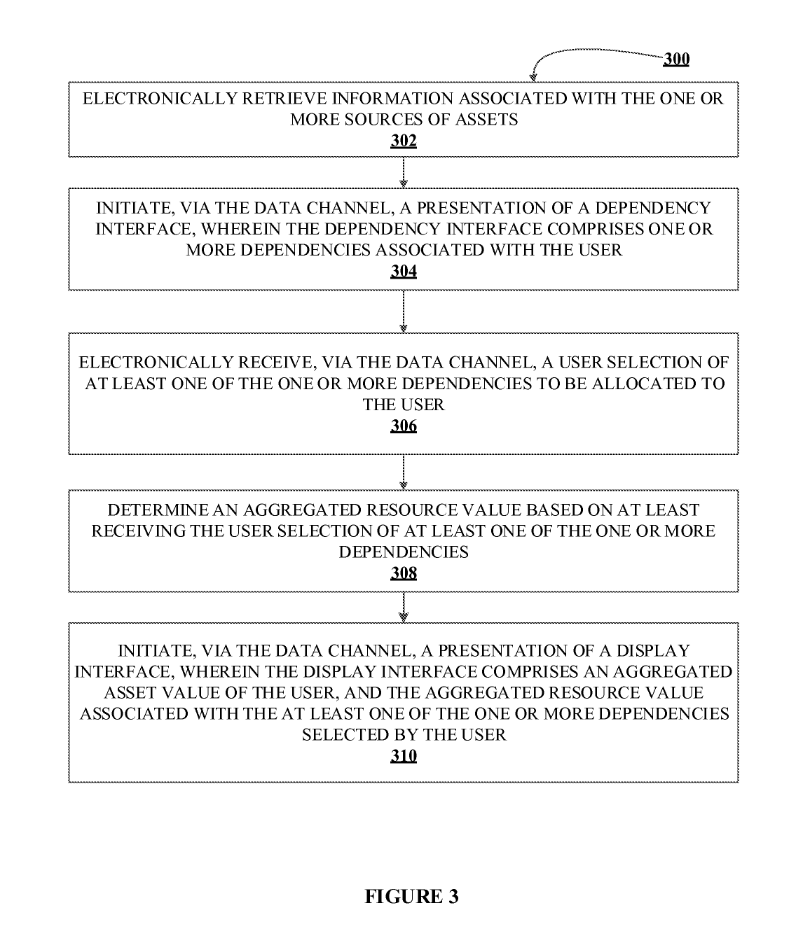

FIG. 3 illustrates a process flow for electronic visualization of dependencies selected by the user against the aggregated asset value of the user 300, in accordance with an embodiment of the invention. In this regard, the system may be configured to establish a communication link with one or more sources of assets for the user. In some embodiments, the information includes an aggregated asset value. The aggregated asset value includes an aggregate of asset values associated with each of the one or more sources of assets. In response, the process flow includes electronically retrieving information associated with the one or more sources of assets, as shown in block 302. In response, the process flow includes initiating a presentation of a dependency interface, wherein the dependency interface comprises one or more dependencies associated with the user, as shown in block 304. In this regard, the system may be configured to establish a communication link with a user device, wherein establishing the communication link creates a wireless data channel between the system and the user device.

Next, as shown in block 306, the process flow includes electronically receiving, via the data channel, a user selection of at least one of the one or more dependencies to be allocated to the user. The allocation of dependencies using the dependency interface is described in detail below. In response, the process flow includes determining an aggregated resource value based on at least receiving the user selection of at least one of the one or more dependencies, as shown in block 308. In one aspect, the aggregated resource value includes an aggregate of the resource values associated with the one or more dependencies allocated to the user. Next, as shown in block 310, the process flow includes initiating, via the data channel, a presentation of the display interface, wherein the display interface comprises an aggregated asset value of the user, and the aggregated resource value associated with the at least one of the one or more dependencies selected by the user.

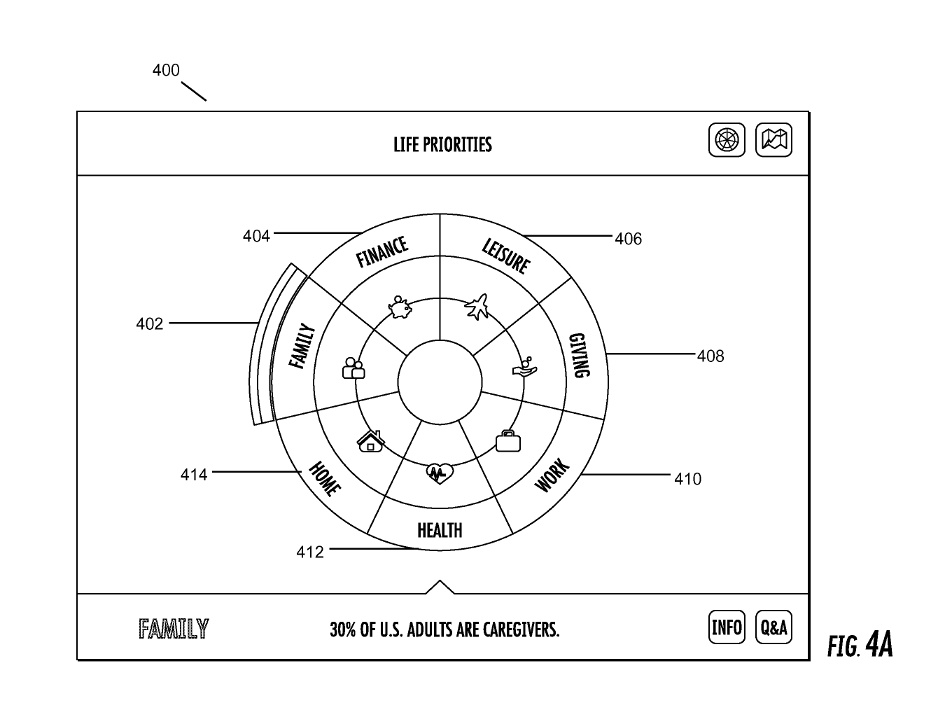

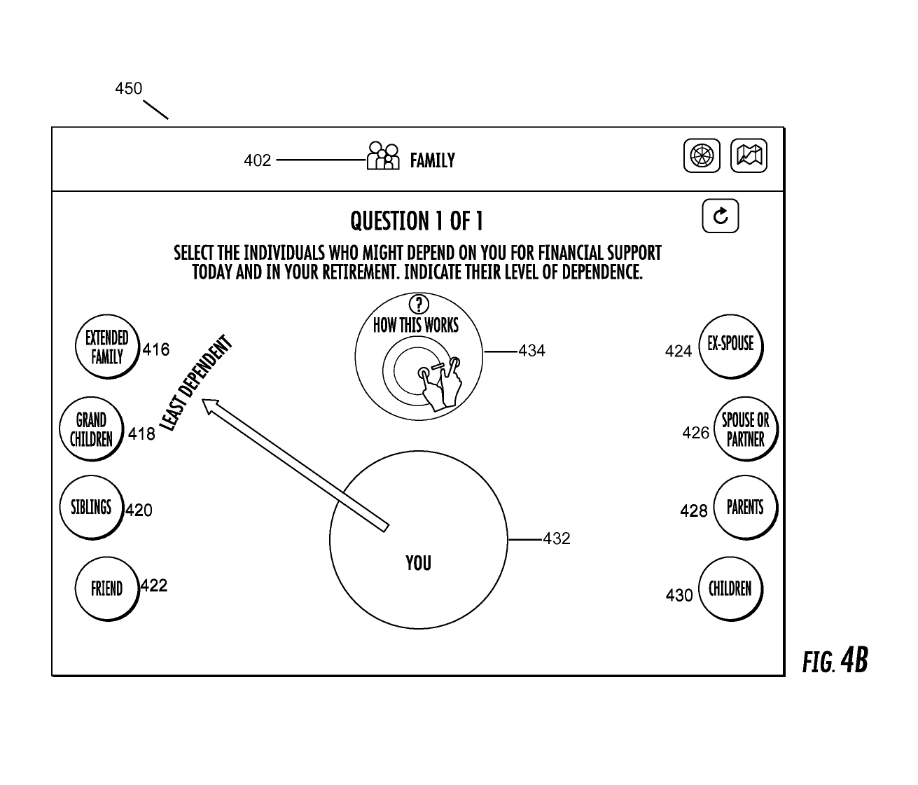

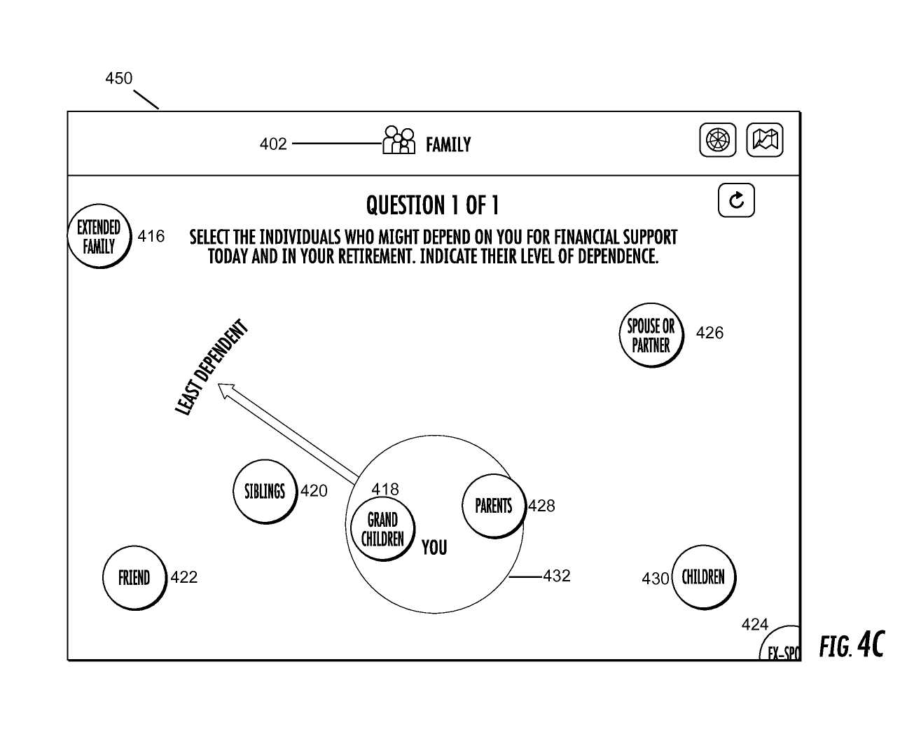

FIG. 4A illustrates an exemplary priority interface 400, in accordance with an embodiment of the invention. As shown in FIG. 4A, the priority interface includes one or more life priorities, including, but not limited to, family 402, finance 404, leisure 406, giving, 408, work 410, health 412, and/or home 414. In this way, each life priority presented by the user may include one or more dependencies. The user may select a life priority to begin the selection of associated dependencies. FIGS. 4B and 4C illustrate an exemplary dependency interface 450 for a family life priority 402 selected by the user, in accordance with an embodiment of the invention. As shown in FIG. 4B, the dependency interface 450 includes, but is not limited to, one or more dependencies such as, extended family 416, grandchildren 418, siblings 420, friend 422, ex-spouse 424, spouse or partner 426, parents 428, and/or children 430. Using the dependency interface 450, the user may select the one or more dependencies. In one aspect, the one or more dependencies may be selected by dragging and dropping the one or more dependencies into the area representing user assets 432. In some embodiments, the dependency interface may provide a tutorial displaying instructions 434 to the user to facilitate the selection of dependencies.

In one aspect, the one or more dependencies may be presented to the user based on a dependency ranking In this regard, the system may be configured to determine a user profile indicating a lifestyle of the user. In some embodiments, the user profile may be determined based on at least one or more past transactions of the user, a geographic location of the user, an income level, an amount of outgoing funds, asset values, liability values, asset types, spending habits, saving habits or the like. In one aspect, the user profile includes at least information identifying the user. In some embodiments, the system may be configured to establish predefined user profiles including, but not limited to travel profiles, homebody, luxury spender, thrifty saver, risk taker, or the like. For example, for the thrifty saver lifestyle the user may indicate that he/she may downsize the user's home in retirement, sell a vacation home, reduce travel expenses, or the like. The profiles may be pre-programed by the financial institution and/or programmable by the user to illustrate how the user plans on living in retirement. Other lifestyles illustrate if the user will spend less, the same, or more during retirement.

In some embodiments, the system may be configured to enable the user to customize the determined user profile. In this regard, the system may be configured to enable the user to select a predetermined user profile and customize the user profile according to the characteristics of the user by providing additional information. In one aspect, the system may be configured to initiate presentation of one or more selectable options on the retirement planning interface on the user device to enable the user to provide the additional information to customize the selected predetermined user profile.

In response to determining the user profile, the system may be configured to determine one or more dependencies for the user in accordance with one or more comparable user profiles associated with one or more other users. In doing so, the user may determine a dependency ranking for the one or more determined dependencies by determining the most common dependencies among users with similar user profiles and sorting them. In response, the system may be configured to present the dependencies one the dependency interface 450 in accordance with the dependency ranking.

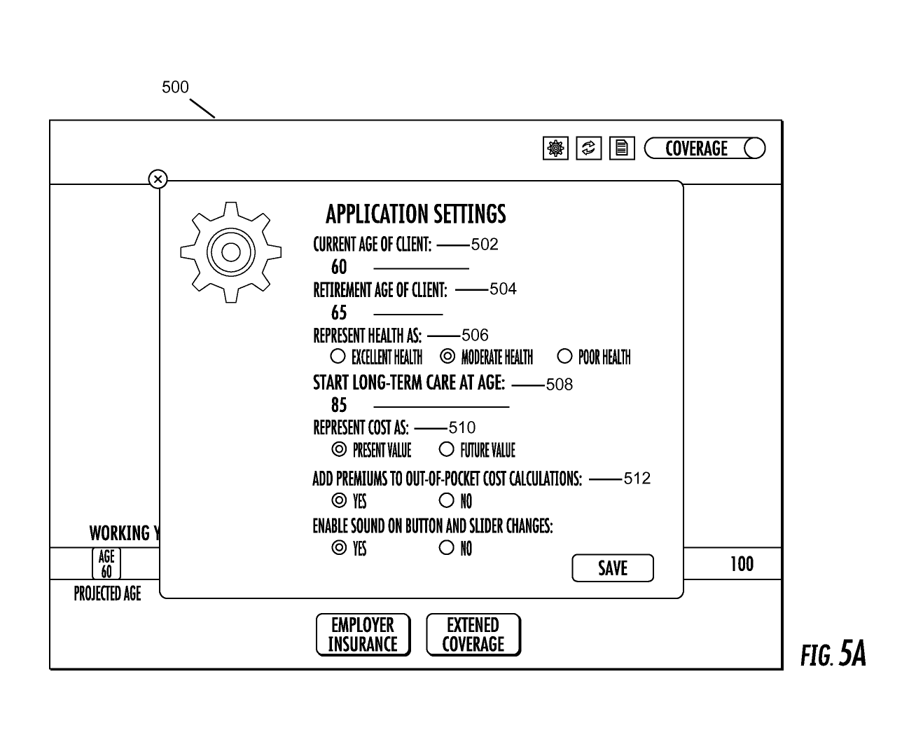

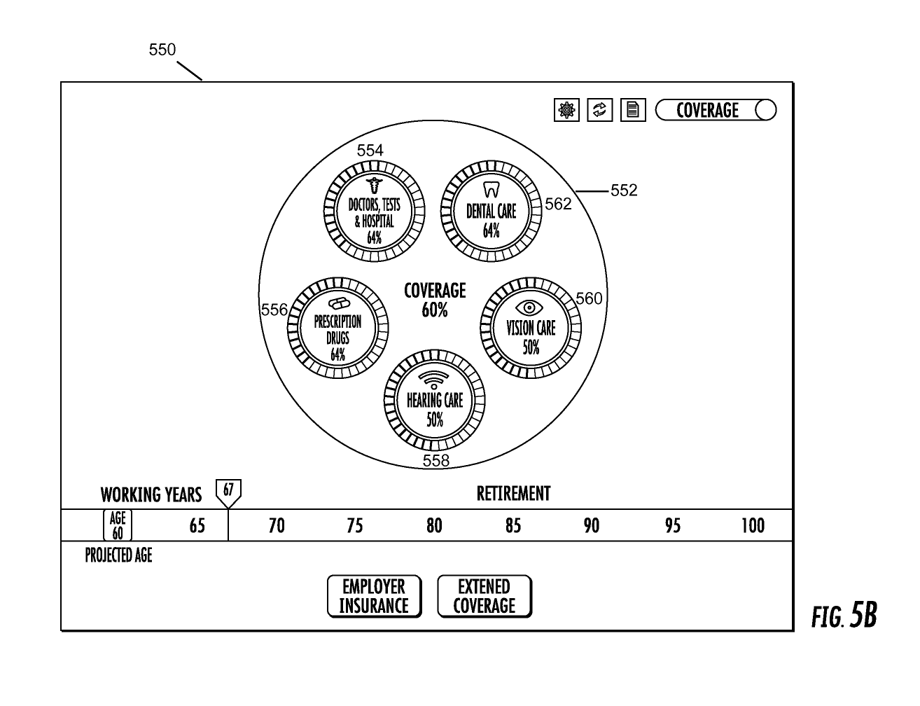

In yet another example, the resource capacity may refer to the user's financial ability to afford healthcare prior to and/or during retirement. In this regard, the resource capacity may be determined based on user information. Accordingly, the system may provide the user with one or more healthcare options (i.e., dependencies) capable of being selected by the user. FIG. 5A illustrates an exemplary interface for adjusting the user's financial ability to afford healthcare post retirement 500, in accordance with an embodiment of the invention. In this regard, the system may be configured to present an interface to receive additional information from the user. The additional information may include, but is not limited to current age of client 502, retirement age of the client 504, represented health 506, long term care start age 508, cost representation 510, and addition of premiums 512.

FIG. 5B illustrates an exemplary dependency interface associated with a health life priority 550, in accordance with an embodiment of an invention. As shown in FIG. 5B, the dependency interface 550 includes, but is not limited to one or more healthcare options (i.e., dependencies), such as doctors, tests and hospital 554, prescription drugs 556, hearing care 558, vision care 560, and dental care 562. In one aspect, the one or more healthcare options may be selected by dragging and dropping the one or more dependencies into the area representing user assets 552.

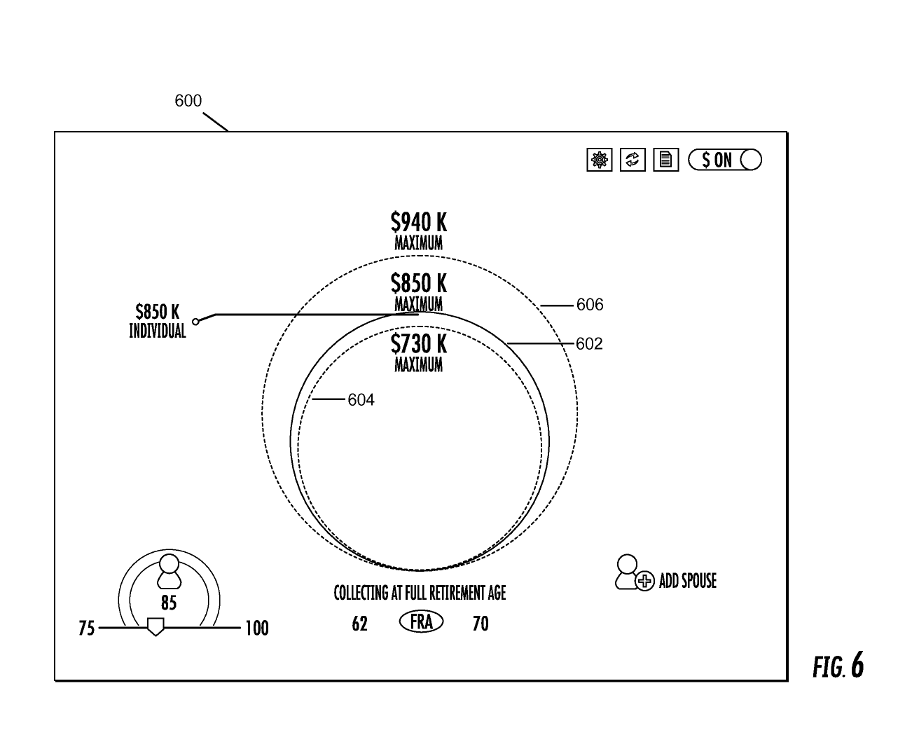

FIG. 6 illustrates a dynamic display interface 600, in accordance with an embodiment of the invention. As shown in FIG. 6, the display interface 600 includes a resource capacity 602, a minimum aggregated resource value 604, and a maximum aggregated resource value 606. By overlaying the resource capacity 602 with the minimum aggregated resource value 604, and a maximum aggregated resource value 606, the user may keep track of the resource capacity and the aggregated resource value.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for analyzing resource capacity based on associated dependencies, the system comprising:
at least one non-transitory storage device;
at least one processor; and
at least one module stored in said storage device and comprising instruction code that is executable by the at least one processor and configured to cause said at least one processor to:
determine a resource capacity associated with an entity;
determine one or more dependencies associated with the entity, wherein the one or more dependencies are associated with a resource value;
receive a user input, wherein the user input comprises a dynamic allocation of the one or more dependencies to the entity;
determine an aggregated resource value based on at least receiving the user input, wherein the aggregated resource value comprises an aggregate of the resource values associated with the one or more dependencies dynamically allocated to the entity; and
initiate a presentation of a dynamic display, wherein the dynamic display comprises an indication of the resource capacity associated with the entity and an aggregated resource value associated with the one or more dependencies dynamically allocated to the entity.

2. The system of claim 1, wherein the module is further configured to cause the at least one processor to determine that the resource value associated with the one or more dependencies are variable between a minimum resource value and a maximum resource value.

3. The system of claim 2, wherein the module is further configured to cause the at least one processor to:
determine the aggregate resource value based on at least receiving the user input, wherein the aggregate resource value comprises a minimum resource value and a maximum resource value.

4. The system of claim 3, wherein the module is further configured to cause the at least one processor to:
initiate the presentation of the minimum aggregated resource value and the maximum aggregated resource value in addition to the resource capacity associated with the entity.

5. The system of claim 1, wherein the module is further configured to cause the at least one processor to:
continuously monitor the resource capacity of the entity and the dynamic allocation of the dependencies to retrieve updated values associated with the resource capacity of the entity and the aggregated resource value associated with the dynamically allocated dependencies, wherein continuously monitoring further comprises continuously updating the dynamic display with the updated values.

6. The system of claim 1, wherein the module is further configured to cause the at least one processor to:
determine that the minimum aggregate resource value is greater than the resource capacity of the entity indicating that the entity is unable to handle the current allocation of the one or more dependencies;
initiate a presentation of a reallocation interface, wherein the reallocation interface comprises the one or more dependencies currently allocated and one or more other dependencies capable of being allocated to the entity; and
receive a user input to redistribute the one or more dependencies, wherein redistributing the one or more dependencies causes a minimum aggregated resource value associated with the redistributed dependencies to be lesser than the resource capacity.

7. The system of claim 1, wherein the module is further configured to cause the at least one processor to:
determine that the minimum aggregate resource value is greater than the resource capacity of the entity indicating that the entity is unable to handle the current allocation of the one or more dependencies;
initiate a presentation of a resource interface, wherein the resource interface comprises one or more options to increase the resource capacity of the entity; and
receive a user input to add one or more resources to the entity, wherein adding the one or more entities causes the minimum aggregated resource value to be lesser than the resource capacity calculated based on the one or more additional resources.

8. The system of claim 1, wherein the module is further configured to cause the at least one processor to:
establish a communication link with one or more sources of assets for the user;
electronically retrieve information associated with the one or more sources of assets, wherein the information comprises an aggregated asset value, wherein the aggregated asset value comprises an aggregate of asset values associated with each of the one or more sources of assets;
establish a communication link with a user device, wherein establishing the communication link creates a wireless data channel to the user device;
initiate, via the data channel, a presentation of a dependency interface, wherein the dependency interface comprises one or more dependencies associated with the user, wherein the one or more dependencies is associated with a resource value;
electronically receive, via the data channel, a user selection of at least one of the one or more dependencies to be allocated to the user;
determine an aggregated resource value based on at least receiving the user selection of at least one of the one or more dependencies, wherein the aggregated resource value comprises an aggregate of the resource values associated with the one or more dependencies allocated to the user; and
initiate, via the data channel, a presentation of a display interface, wherein the display interface comprises an aggregated asset value of the user, and the aggregated resource value associated with the at least one of the one or more dependencies selected by the user.

9. A computerized method for analyzing resource capacity based on associated dependencies, the method comprising:
determining, using a computing device processor, a resource capacity associated with an entity;
determining, using a computing device processor, one or more dependencies associated with the entity, wherein the one or more dependencies are associated with a resource value;
receiving, using a computing device processor, a user input, wherein the user input comprises a dynamic allocation of the one or more dependencies to the entity;
determining, using a computing device processor, an aggregated resource value based on at least receiving the user input, wherein the aggregated resource value comprises an aggregate of the resource values associated with the one or more dependencies dynamically allocated to the entity; and
initiating, using a computing device processor, a presentation of a dynamic display, wherein the dynamic display comprises an indication of the resource capacity associated with the entity and an aggregated resource value associated with the one or more dependencies dynamically allocated to the entity.

10. The method of claim 9, wherein the method comprises determining that the resource value associated with the one or more dependencies are variable between a minimum resource value and a maximum resource value.

11. The method of claim 10, wherein the method further comprises determining the aggregate resource value based on at least receiving the user input, wherein the aggregate resource value comprises a minimum resource value and a maximum resource value.

12. The method of claim 11, wherein the method further comprises initiating the presentation of the minimum aggregated resource value and the maximum aggregated resource value in addition to the resource capacity associated with the entity.

13. The method of claim 9, wherein the method further comprises continuously monitoring the resource capacity of the entity and the dynamic allocation of the dependencies to retrieve updated values associated with the resource capacity of the entity and the aggregated resource value associated with the dynamically allocated dependencies, wherein continuously monitoring further comprises continuously updating the dynamic display with the updated values.

14. The method of claim 9, wherein the method further comprises:
determining that the minimum aggregate resource value is greater than the resource capacity of the entity indicating that the entity is unable to handle the current allocation of the one or more dependencies;
initiating a presentation of a reallocation interface, wherein the reallocation interface comprises the one or more dependencies currently allocated and one or more other dependencies capable of being allocated to the entity; and
receiving a user input to redistribute the one or more dependencies, wherein redistributing the one or more dependencies causes a minimum aggregated resource value associated with the redistributed dependencies to be lesser than the resource capacity.

15. The method of claim 9, wherein the method further comprises:
determining that the minimum aggregate resource value is greater than the resource capacity of the entity indicating that the entity is unable to handle the current allocation of the one or more dependencies;
initiating a presentation of a resource interface, wherein the resource interface comprises one or more options to increase the resource capacity of the entity; and
receiving a user input to add one or more resources to the entity, wherein adding the one or more entities causes the minimum aggregated resource value to be lesser than the resource capacity calculated based on the one or more additional resources.

16. The method of claim 9, wherein the method further comprises:
establishing a communication link with one or more sources of assets for the user;
electronically retrieving information associated with the one or more sources of assets, wherein the information comprises an aggregated asset value, wherein the aggregated asset value comprises an aggregate of asset values associated with each of the one or more sources of assets;
establishing a communication link with a user device, wherein establishing the communication link creates a wireless data channel to the user device;
initiating, via the data channel, a presentation of a dependency interface, wherein the dependency interface comprises one or more dependencies associated with the user, wherein the one or more dependencies is associated with a resource value;
electronically receiving, via the data channel, a user selection of at least one of the one or more dependencies to be allocated to the user;
determining an aggregated resource value based on at least receiving the user selection of at least one of the one or more dependencies, wherein the aggregated resource value comprises an aggregate of the resource values associated with the one or more dependencies allocated to the user; and
initiating, via the data channel, a presentation of a display interface, wherein the display interface comprises an aggregated asset value of the user, and the aggregated resource value associated with the at least one of the one or more dependencies selected by the user.

17. A computer program product for analyzing resource capacity based on associated dependencies, the computer program product comprising a non-transitory computer-readable medium comprising code causing a first apparatus to:
determine a resource capacity associated with an entity;
determine one or more dependencies associated with the entity, wherein the one or more dependencies are associated with a resource value;
receive a user input, wherein the user input comprises a dynamic allocation of the one or more dependencies to the entity;
determine an aggregated resource value based on at least receiving the user input, wherein the aggregated resource value comprises an aggregate of the resource values associated with the one or more dependencies dynamically allocated to the entity; and
initiate a presentation of a dynamic display, wherein the dynamic display comprises an indication of the resource capacity associated with the entity and an aggregated resource value associated with the one or more dependencies dynamically allocated to the entity.

18. The computer program product of claim 17, wherein the first apparatus is further configured to:
continuously monitor the resource capacity of the entity and the dynamic allocation of the dependencies to retrieve updated values associated with the resource capacity of the entity and the aggregated resource value associated with the dynamically allocated dependencies, wherein continuously monitoring further comprises continuously updating the dynamic display with the updated values.

19. The computer program product of claim 17, wherein the first apparatus is further configured to:
determine that the minimum aggregate resource value is greater than the resource capacity of the entity indicating that the entity is unable to handle the current allocation of the one or more dependencies;
initiate a presentation of a resource interface, wherein the resource interface comprises one or more options to increase the resource capacity of the entity; and
receive a user input to add one or more resources to the entity, wherein adding the one or more entities causes the minimum aggregated resource value to be lesser than the resource capacity calculated based on the one or more additional resources.

20. The computer program product of claim 17, wherein the first apparatus is further configured to, wherein the method further comprises:
establish a communication link with one or more sources of assets for the user;
electronically retrieve information associated with the one or more sources of assets, wherein the information comprises an aggregated asset value, wherein the aggregated asset value comprises an aggregate of asset values associated with each of the one or more sources of assets;
establish a communication link with a user device, wherein establishing the communication link creates a wireless data channel to the user device;
initiate, via the data channel, a presentation of a dependency interface, wherein the dependency interface comprises one or more dependencies associated with the user, wherein the one or more dependencies is associated with a resource value;
electronically receive, via the data channel, a user selection of at least one of the one or more dependencies to be allocated to the user;
determine an aggregated resource value based on at least receiving the user selection of at least one of the one or more dependencies, wherein the aggregated resource value comprises an aggregate of the resource values associated with the one or more dependencies allocated to the user; and
initiate, via the data channel, a presentation of a display interface, wherein the display interface comprises an aggregated asset value of the user, and the aggregated resource value associated with the at least one of the one or more dependencies selected by the user.
